(19) United States
(12) Patent Application Publication
(10) Pub. No.: US 2008/0165544 A1
(43) Pub. Date: Jul. 10, 2008

(54) PROTECTIVE ENCLOSURE FOR LIGHTING INSTRUMENTS

(75) Inventors: Martin S. Lazarus, Chicago, IL (US); Edwin B. Jones, Chicago, IL (US)

Correspondence Address: BARNES & THORNBURG LLP, P.O. BOX 2786, CHICAGO, IL, 60690-2786, US

(73) Assignee: CHICAGO SPOTLIGHT, INC., Chicago, IL (US)

(21) Appl. No.: 11/969,426

(22) Filed: Jan. 4, 2008

Related U.S. Application Data
(60) Provisional application No. 60/883,638, filed on Jan. 5, 2007.

(51) Int. Cl. F21V 15/00

(52) U.S. Cl. 362/362

(57) ABSTRACT

A protective enclosure for a lighting fixture, for example, stage- or studio-type lighting instruments to protect the lighting fixture from damage when used in multipurpose gymnasium/auditorium facilities.

### BACKGROUND

The present disclosure relates generally to a protective enclosure for a lighting fixture or other equipment. In particular, the protective enclosure of the present disclosure is directed towards an apparatus that may be mounted in connection with stage- or studio-type lighting instruments in multipurpose facilities to protect the lighting instruments from damage.

It is common for organizations such as churches and schools to have multipurpose facilities that are used for entertainment and athletic purposes. One example of this would be a school gymnasium having a stage, which the school uses for athletic events and theatrical productions. Such a multipurpose facility is commonly referred to as a gymnatorium. Stage lights, video projectors, or other delicate equipment may be permanently mounted in a location that is susceptible to being struck by objects such as basketballs, volleyballs and the like when the facility is used for athletic purposes. Because stage and studio lighting instruments are expensive, ranging in price from several hundred to several thousand dollars apiece, it is desirable to protect the lighting instruments and equipment from impacts by the balls and other objects when the multipurpose facilities are being used for athletic purposes.

### SUMMARY

One aspect of the present disclosure is to protect stage/studio type lighting instruments and other delicate equipment when used in multipurpose spaces where theatrical/musical/TV/film/video productions share space with athletic events.

Another aspect of the present disclosure is allowing access to a lighting instrument or other equipment within the protective enclosure for focusing and color changing for individual productions. The protective enclosure of the present disclosure may be equipped with a motorized device to allow movement of a lighting instrument, including panning from side to side and tilting up and down, and for focusing. The protective enclosure of the present disclosure may also accommodate a color changing device to allow a lighting instrument to project a beam of light in more than one color.

Yet another aspect of the present disclosure is to provide a protective enclosure that allows for unrestricted movement of a lighting instrument. Enclosures that have been built in the past were often square, rectangular or triangular in shape, which restricts the movement of the lighting instruments unless they are made very large.

Yet another aspect of the present disclosure provides access to the interior of the protective enclosure for a person on a lift or on a ladder at a considerable height above the floor.

The protective enclosure of the present disclosure includes a frame that may be fabricated of steel or aluminum shapes, and a protector applied to the face, top, sides and back of the frame. The protector is designed to withstand the impacts of the type of balls or other objects used in the space. The protector shall also be designed with the intent of blocking the least amount of light projected from the lighting instrument. The protector as described herein, may be constructed from a wire mesh, plexiglass, or other suitable material. The frame of the enclosure may include an equipment mount that may comprise a pipe/tube/channel inside the enclosure to support the lighting instruments and any power distribution equipment needed for the lighting instruments. The face (the side where the light shall be projected) of the enclosure is curved to a similar radius of the arc of the tilt of the lighting instruments to allow full tilt without interference to the movement of the instrument. The back side of the enclosure may have a closable opening that includes doors suspended on tracks to allow the doors to traverse side to side for ease of access while on personnel lifts. The enclosure may be welded or bolted or welded and bolted together.

### BRIEF DESCRIPTION OF THE DRAWINGS

The present disclosure will be described hereafter with reference to the attached drawings which are given as a non-limiting example only, in which:

FIG. 1 is a side elevation view of an embodiment of the protective enclosure of the present disclosure;

FIG. 2 is a front elevation view of the protective enclosure of FIG. 1;

FIG. 3 is a front perspective view showing the frame of the protective enclosure of FIG. 1; and

FIG. 4 is a rear elevation view of the protective enclosure of FIG. 1 showing doors and door tracks.

FIG. 5 is a side elevation view of another embodiment of the protective enclosure including access doors provided on the face of the enclosure.

### DETAILED DESCRIPTION

While the present disclosure will be described fully hereinafter with reference to the accompanying drawings in which particular embodiments are shown, it is understood at the outset that persons skilled in the art may modify the disclosure herein described while still achieving the desired result of this disclosure. Accordingly, the description which follows is to be understood as a broad informative disclosure directed to persons skilled in the appropriate arts and not as limitations of the present disclosure.

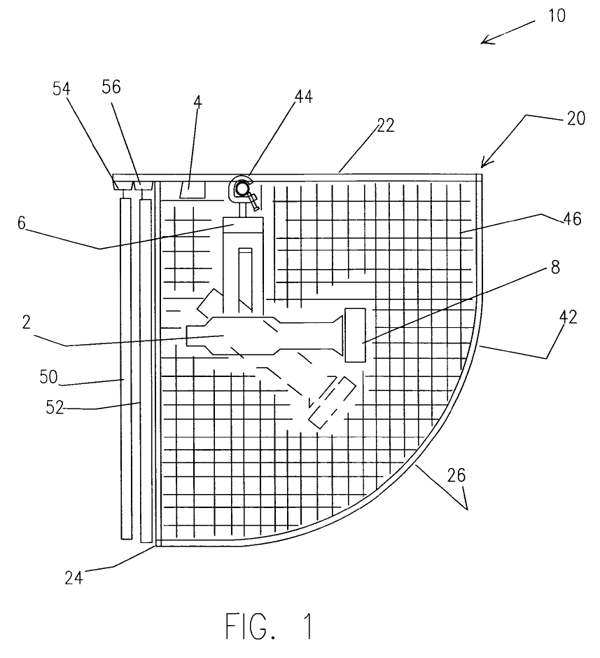

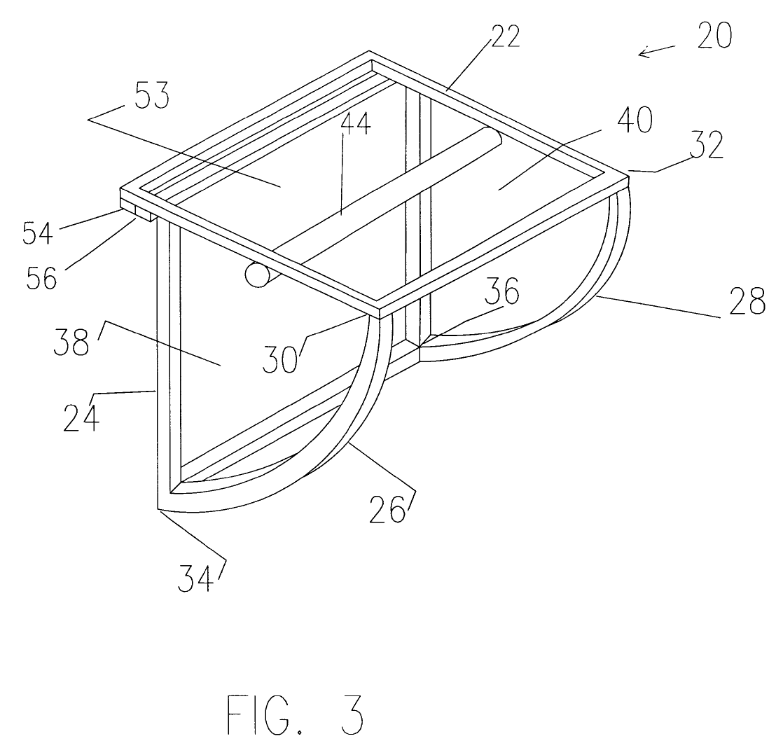

The protective enclosure 10 of the present disclosure, as shown in FIGS. 1 through 4, includes a frame 20 having a top structure 22 and a rear structure 24. A pair of side members 26, 28 are each coupled to a forward portion of the top structure 22 and a lower portion of the rear structure 24. In the embodiment shown in FIG. 3, side members 26 and 28 are each connected to a front corner 30, 32 of top structure 22 and a lower corner 34, 36 of rear structure 24 respectively, with side member 26 defining a first side 38 in cooperation with top structure 22 and rear structure 24, and side member 28 defining a second side 40 in cooperation with top structure 22 and rear structure 24 that is opposite to the first side. Side members 26 and 28 are curved, defining an arcuate face 42 between them, as shown in FIG. 1.

Lighting instruments 2 may include motorized components that allow the lighting instrument to pivot about one or more axes so that a light beam may be directed to multiple locations. Alternatively, a lighting instrument 2 may be manually adjusted and set. In either instance, the lighting instrument 2 must have sufficient clearance to move unobstructed within the enclosure of the present disclosure.

In one embodiment of the present disclosure the frame 20 may be constructed from 1 inch square steel tubing with 14 gauge wall. Frame members may be welded together, bolted together, or welded and bolted together, as is known in the art. It should be understood, that is acceptable for the frame to be constructed from steel or aluminum round tubing, C-channel, angle iron, UNISTRUT® framing channel, or other material known in the art suitable for this purpose.

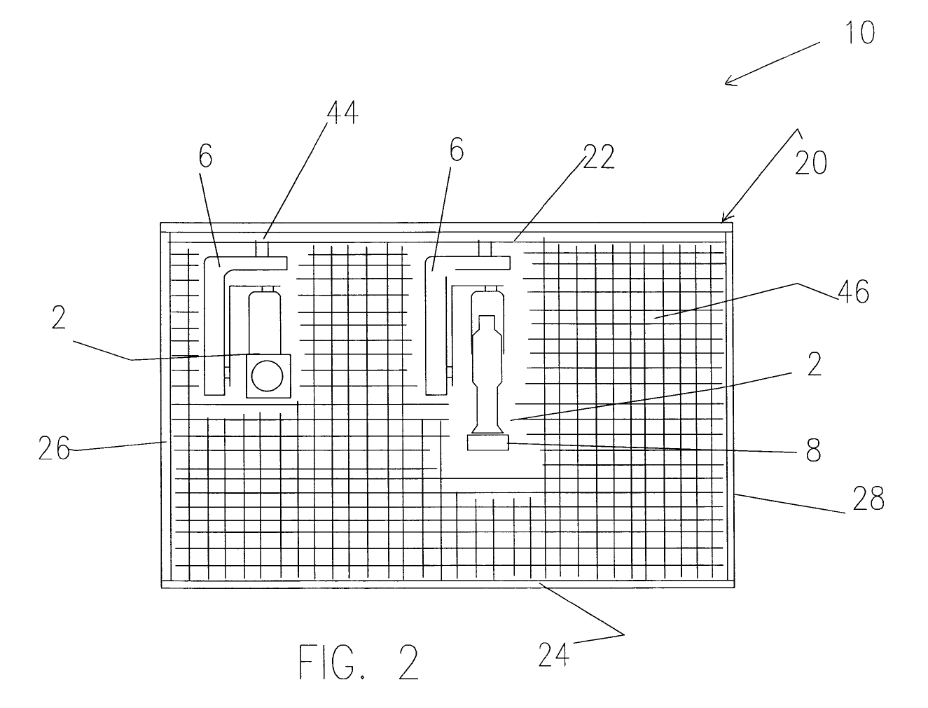

An equipment mount 44 is provided along the top of the protective enclosure 10 attached to top structure 22, as shown in FIG. 3. Equipment mount 44 provides support for a lighting instrument 2 as shown in FIGS. 1 and 2. Equipment mount 44 may also support any auxiliary electrical or mechanical accessories 4 such as electrical junction boxes, gear motors, color changers, and the like. The equipment mount 44 may be constructed from a length of 1 1/2 inch diameter schedule 40 steel pipe, attached to the top structure 22 by welding, bolting, or other fastening means known in the art. A length of UNISTRUT® framing channel or other steel or aluminum member may also be acceptable.

A protector member 46 is attached to the frame providing an enclosure for the lighting instrument 2. In one embodiment, the protector member 46 is constructed from wire mesh, which is attached to the top structure 22, the face 42, and each side 38, 40. Doors 50, 52 are also provided with wire mesh and are configured to close an opening 53 in rear structure 24 while allowing access to the interior of the protective enclosure 10. Thus, in this embodiment, the protective enclosure 10 provides a complete enclosure. In an alternative embodiment, the protector 46 may be omitted from top structure when the protective enclosure 10 is mounted flush with a ceiling or other surface.

An acceptable mesh for protector member 46 includes a 2 inch square mesh of 0.118 inch steel wire cloth. Other acceptable meshes include hex netting, commonly referred to as “chicken wire,” or hardware cloth. Protector member 46 must have sufficient rigidity to protect the lighting instrument 2, or other contents of the protective enclosure 10 from impact by objects such as athletic balls, yet have sufficiently open space to allow a beam of light to pass through without perceptible interference. Alternative embodiments may include protectors formed from plexiglass polycarbonate, or other rigid, durable materials that allow for passage of a light beam.

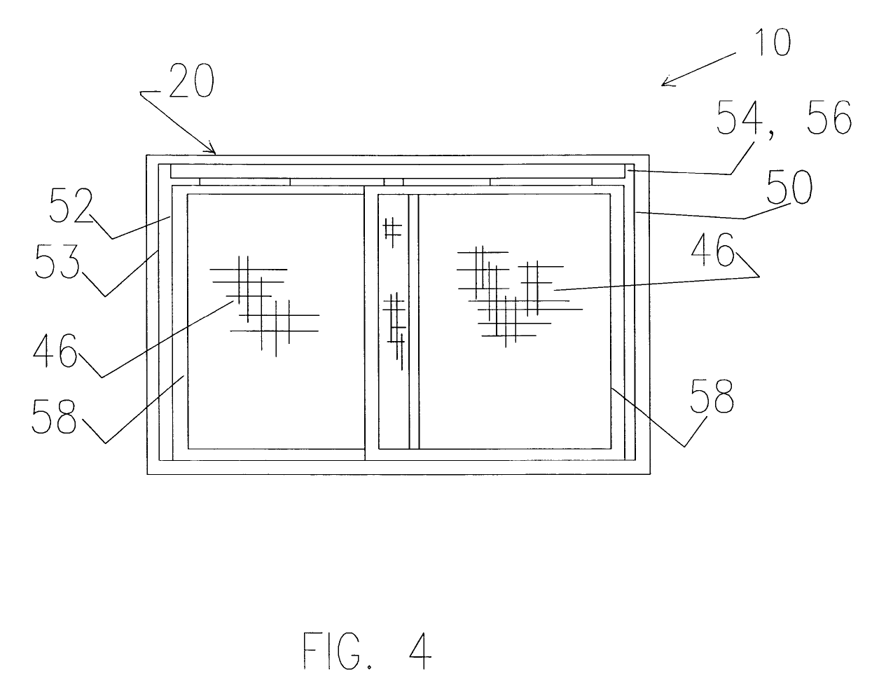

Referring now to FIG. 4, access doors 50, 52 are provided on the rear of the protective enclosure 10 of the present disclosure. Each door 50, 52 includes a door frame 58 and protector member 46 attached to the door frame 58. Each door frame 58 may be constructed from the same structural materials as the frame 20, e.g., 1 inch square steel tubing, or other suitable material. Door tracks 54, 56 are mounted over the opening 53 defined by the rear structure 24 of the frame 20. The door tracks 54, 56 may be constructed from UNISTRUT® framing channel. Rollers (not shown), attached to each door 50, 52, are coupled to and cooperate with the door tracks 54, 56 suspending the doors from the door tracks and allowing the doors 50, 52 to translationally move within the frame opening 53. As shown in FIG. 4, two doors 50, 52 are offset from each other allowing each door to slide in front of or behind the other.

This sliding door arrangement allows access to the lighting instrument 2 within the protective enclosure 10 without the door swinging out of or down from the confines of the frame 20. This is beneficial because lighting instruments of this type can be mounted near a ceiling or at a considerable height above the floor, and a person that must access the lighting instrument 2 is often on a lift or a ladder, where clearing a pivoting door (either vertically or horizontally) may be difficult and dangerous.

Although the embodiment shown in FIG. 4 has two overlapping sliding doors 50, 52, a single door is equally acceptable. A single door may be configured to cover only a portion of the rear or the entire rear with a door track extending beyond a side member.

The protective enclosure 10 of the present disclosure may be mounted to structural elements of the multipurpose facility in which it is used. For example, gymnatoriums typically have exposed roof trusses, bar joists, I-beams, or other structural components above the space. The protective enclosure may be clamped directly to such building structural components by a beam clamp or other means known in the art. Alternatively, the protective enclosure 10 may be suspended from building structural components by threaded rod, cable, or other suitable means. Finally, in spaces having a finished ceiling, the protective enclosure 10 may be mounted directly to the ceiling of the multipurpose facility.

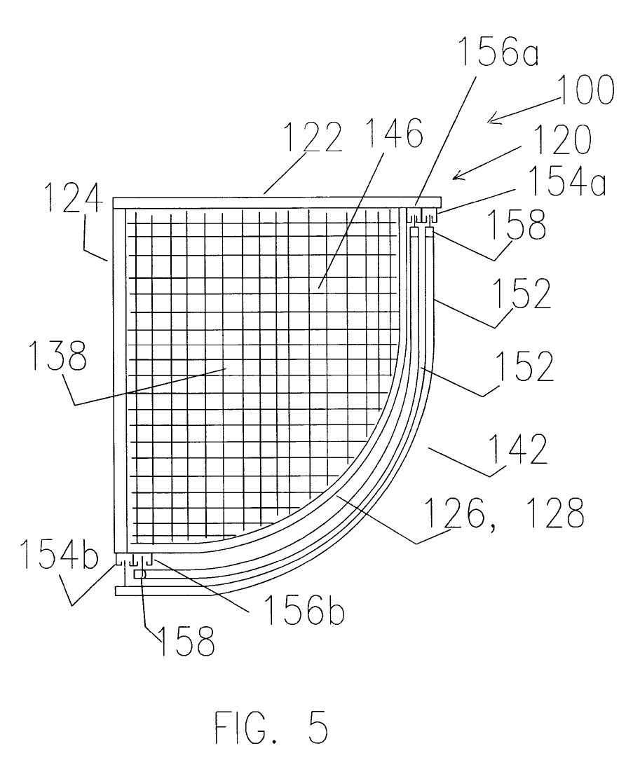

Another embodiment of the protective enclosure 100 includes access doors 150, 152 provided on the face 142 of the enclosure, as shown in FIG. 5. This embodiment of protective enclosure 100 may be used when the lighting instrument or other equipment is mounted on a wall, requiring access from the face 142 of the enclosure. Alternatively, protective enclosure 100 may be ceiling mounted as described previously.

Referring to FIG. 5, protective enclosure includes a frame 120 having a top structure 122 and a rear structure 124. A pair of side members 126, 128 are each coupled to a forward portion of the top structure 122 and a lower portion of rear structure 124. Side member 126 defining a first side 138 in cooperation with top structure 122 and rear structure 124, while side member 128 defines a second side (not shown) in cooperation with top structure 122 and rear structure 124 opposite to the first side 138. Side members 126 and 128 are curved, defining an arcuate face 142 between them. As described above, a protector member 146 is attached to the frame 120 of the enclosure 100.

Access doors 150, 152 are provided on the face 142 of enclosure 100. Each door includes a door frame 158 and a protector member 146 attached to the door frame 158. Each door frame 158 may be constructed from the same structural materials as the frame 120. In this embodiment, door frames 158 are curved to correspond to the arcuate configuration of face 142.

Enclosure 100 further includes upper outboard 154a and inboard 156a door tracks and lower outboard 154b and inboard 156b door tracks. Rollers (not shown), attached to each door 150, 152, are coupled to and cooperate with the upper 154a, 156a and lower 154b, 156b door tracks, suspending the doors from the door tracks and allowing the doors 150, 152 to translationally move across the face 142 of enclosure 100. Doors 150, 152 are offset from each other allowing each door to slide in front of or behind the other. Also, as similarly described above, a single door may be configured to cover face 142 or a portion thereof.

It is envisioned that the protective enclosures 10, 100 of the present disclosure may be modular in nature, allowing any number of frames 20, 120 to be connected together to provide a protective enclosure of variable size, depending on a particular application. It is also envisioned that the protective enclosures 10, 100 of the present disclosure may be configured as a self-contained lighting instrument itself, including a protective enclosure 10, 100 having pre-hung apparatus such as a lighting instrument 2, motorized arm 6, color changer 8, power supply or other auxiliary apparatus 4, allowing for modular installation.

The protective enclosure 10 can be sized to allow use of fixed lighting instruments or lighting instruments that can be focused remotely through use of motors and gearboxes. Any of the lighting instruments may have mechanisms to allow remote color changing. A machine such as the RIGHT ARM™, built by Apollo Design Technology, Inc. may be used to allow lighting instruments that are normally used in a fixed position to be remotely focused. A standard color changer, such as the FORERUNNER™, built by Wybron may be used with lighting instruments to allow remote color changes.

1. A protective enclosure for an instrument comprising:
a frame including a face and defining an inner region configured to accommodate the instrument;
a protector attached to the frame; and
at least one opening in the frame configured to allow access to the instrument.

2. The protective enclosure of claim 1 further including an equipment mount coupled to the frame and disposed within the inner region.

3. The protective enclosure of claim 2 wherein the frame further comprises a top structure, a back structure, a first side adjacent to the top and back, and a second side opposite the first side and adjacent to the top and back.

4. The protective enclosure of claim 3 wherein the protector is attached to at least one of the face, the first side, and the second side.

5. The protective enclosure of claim 4 further comprising a first side member coupled to a forward portion of the top structure and a lower portion of back structure, and a second side member positioned opposite the first side member and coupled to a forward portion of the top structure and a lower portion of back structure.

6. The protective enclosure of claim 5 wherein the first side member and the second side member include a curved portion defining an arcuate face therebetween.

7. The protective enclosure of claim 3 further comprising a closable opening defined by the back structure, the closable opening configured to allow access to the inner region.

8. The protective enclosure of claim 7 further including a door movably coupled to the back structure, the door including a door frame and a protector member attached to the door frame.

9. The protective enclosure of claim 8 wherein said door is slidably coupled to the back structure such that the door is configured to translate relative to the back structure between an open position and a closed position.

10. The protective enclosure of claim 9 further comprising a door track attached to the back structure, the door track configured to received and support the door allowing slidable coupling of the door relative to the back structure.

11. The protective enclosure of claim 10 further comprising a second door received within the door track and disposed behind the first door wherein the first door and second door are configured to translate relative to each other and the back structure.

12. The protective enclosure of claim 3 wherein the first side member and the second side member include a curved portion defining an arcuate face therebetween, and further including a closable opening within the arcuate face configured to allow access to the inner region.

13. The protective enclosure of claim 12 further comprising a door slidably coupled to the arcuate face of the enclosure such that the door is configured to translate relative to the face between an open and closed position.

14. The protective enclosure of claim 13 further comprising a second door coupled to the arcuate face of the enclosure.

15. The protective enclosure of claim 14 wherein the first door and second door are configured to translate relative to each other and the arcuate face.

16. A self-contained protected instrument comprising:
a frame, including a top structure, a back structure, a first side adjacent to the top and back structure, and a second side opposite the first side and adjacent to the top and back, and an arcuate face defined between the first side and the second side, wherein the frame defines an inner region;
a protector member attached to the frame;
an equipment mount disposed within the inner region; and
an instrument coupled to the equipment mount.

17. The self-contained protected instrument of claim 16 further comprising a closable opening defined including at least one door slidably coupled to the frame such that the door translates relative to the frame between an open position and a closed position.

18. The self-contained protected instrument of claim 17 further comprising a second door slidably coupled to the frame, wherein the first door and second door are configured to translate relative to each other and the frame.
